(19) United States
(12) Patent Application Publication
(10) Pub. No.: US 2025/0337828 A1
(43) Pub. Date: Oct. 30, 2025

(54) STAND DEVICE FOR MOBILE DEVICE AND RELATED METHODS

(71) Applicant: Francisco José RICHARDSON, Winter Park, FL (US)

(72) Inventor: Francisco José RICHARDSON, Winter Park, FL (US)

(21) Appl. No.: 19/187,173

(22) Filed: Apr. 23, 2025

Related U.S. Application Data
(60) Provisional application No. 63/638,504, filed on Apr. 25, 2024.

(51) Int. Cl. H04M 1/04; F16M 11/38

(52) U.S. Cl. CPC H04M 1/04; F16M 11/38

(57) ABSTRACT

A stand includes a housing having a first major surface, a second major surface opposite the first major surface and to define a recess, a first side extending between the first major surface and the second major surface, and a second side extending between the first major surface and the second major surface and opposite the first side. The stand also includes first and second folding legs respectively coupled to the first side and the second side. Each of the first and second folding legs moves freely from each other, and the first and second folding legs switch between a first extended state and a second retracted state. The first and second folding legs are within the recess in the second retracted state, and the first and second folding legs extend outward and away from a mobile device to rest on a surface in the first extended state.

### RELATED APPLICATION

This application is based upon prior filed copending Application No. 63/638,504 filed Apr. 25, 2024, the entire subject matter of which is incorporated herein by reference in its entirety.

### TECHNICAL FIELD

The present disclosure relates to the field of mobile devices, and, more particularly, to a stand for mobile devices and related methods.

### BACKGROUND

As people age, the lenses within the eye become more rigid and less flexible. Because of this, the ability to see near items may become more difficult. A common approach to this issue is reading glasses.

Because of this, the reading glasses industry is quite robust (i.e., worldwide sales of over $40 billion). Further, in low light applications, the ability to read may be additionally difficult. Because of this, low vision reading devices have become quite common. In early approaches, the devices were mechanical in nature, for example, a typical magnifying glass combined with a battery powered light. With mobile wireless communications devices becoming ubiquitous in modern society, there are some electronic approaches. For example, one approach comprises an electronic magnifier, as available from Eschenbach Optik of America, Inc. of Danbury, CT.

### SUMMARY

Generally, a stand is for a mobile device, and the stand includes a housing. The housing has a first major surface abutting the mobile device, a second major surface opposite the first major surface and to define a recess, a first side extending between the first major surface and the second major surface, and a second side extending between the first major surface and the second major surface and opposite the first side. The stand also includes first and second folding legs respectively coupled to the first side and the second side. Each of the first and second folding legs moves freely from each other, and the first and second folding legs switch between a first extended state and a second retracted state. The first and second folding legs are within the recess in the second retracted state, and the first and second folding legs extend outward and away from the mobile device to rest on a surface in the first extended state. The housing has a height less than that of the mobile device.

In particular, the second major surface may comprise a peripheral wall extending about a perimeter of the housing, and a medial platform within the peripheral wall. The second major surface may define the recess to comprise an annular-shaped recess between the peripheral wall and the medial platform. The first and second folding legs may be flush with the medial platform in the second retracted state.

Each of the first and second folding legs may comprise a body with a medial opening therein, and a pin coupled between the body and the housing. The body of each of the first and second folding legs may define a flat distal end, the flat distal ends of the first and second folding legs to abut each other in the first extended state.

Also, the first major surface may comprise an annular recess for attachment to the mobile device. The second major surface may comprise first and second hinges respectively at the first and second sides and to respectively receive the first and second folding legs. Corners of the housing may be truncated in some embodiments.

Another aspect is directed to a method for making a stand for a mobile device. The method comprises forming a housing having a first major surface abutting the mobile device, a second major surface opposite the first major surface and to define a recess, a first side extending between the first major surface and the second major surface, and a second side extending between the first major surface and the second major surface and opposite the first side. The method also includes coupling first and second folding legs respectively to the first side and the second side. Each of the first and second folding legs moves freely from each other, and the first and second folding legs switch between a first extended state and a second retracted state. The first and second folding legs are within the recess in the second retracted state, and the first and second folding legs extend outward and away from the mobile device to rest on a surface in the first extended state. The housing has a height less than that of the mobile device.

### BRIEF DESCRIPTION OF THE DRAWINGS

FIG. 1 is a perspective view of a stand, in a first extended state, attached to a mobile device, according to the present disclosure.

FIG. 2 is another perspective view of the stand and mobile device from FIG. 1.

FIG. 3 is a side view of the stand and mobile device from FIG. 1.

FIG. 4 is another perspective view of the stand and mobile device from FIG. 1.

FIG. 5 is another perspective view of the stand, in a second retracted state, and mobile device from FIG. 1.

FIG. 6 is a bottom plan view of the stand from FIG. 1 without the mobile device.

FIG. 7 is a top plan view of the stand from FIG. 1 without the mobile device and without the first and second legs.

FIG. 8 is a cross-sectional view of the stand from FIG. 1 along line 8-8 of FIG. 6.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

In typical approaches to reading aid devices, the devices are bulky and special purpose built. Because of this, these approaches are less convenient for the user. In contrast, the presently disclosed stand has a compact design that permits the user to readily carry the mobile device, for example, within a pocket. Further, unlike special purpose-built devices that may be costly (e.g., the electronic magnifier, as available from Eschenbach Optik of America, Inc. of Danbury, CT.), the stand permits any mobile device to be converted into a reading aid device, thereby reducing the cost. Also, the user needs only carry the mobile device and the stand rather than a second electronic magnifier device. In fact, due to the compact nature of the stand, the user may install the stand onto the mobile device permanently and carry the combined package.

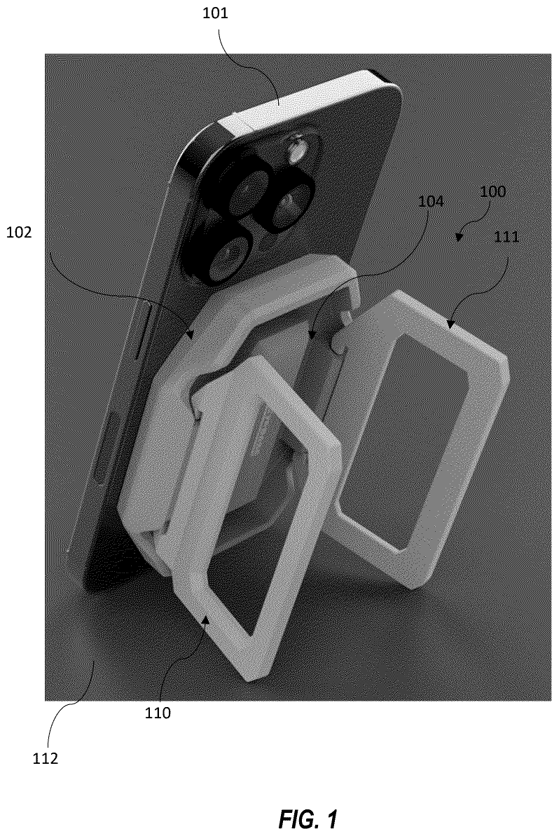

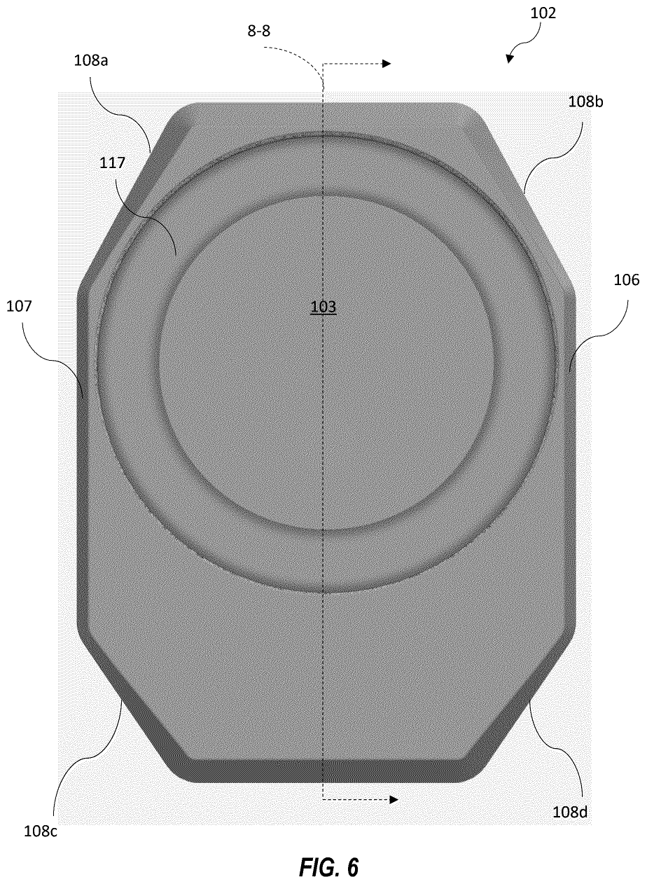

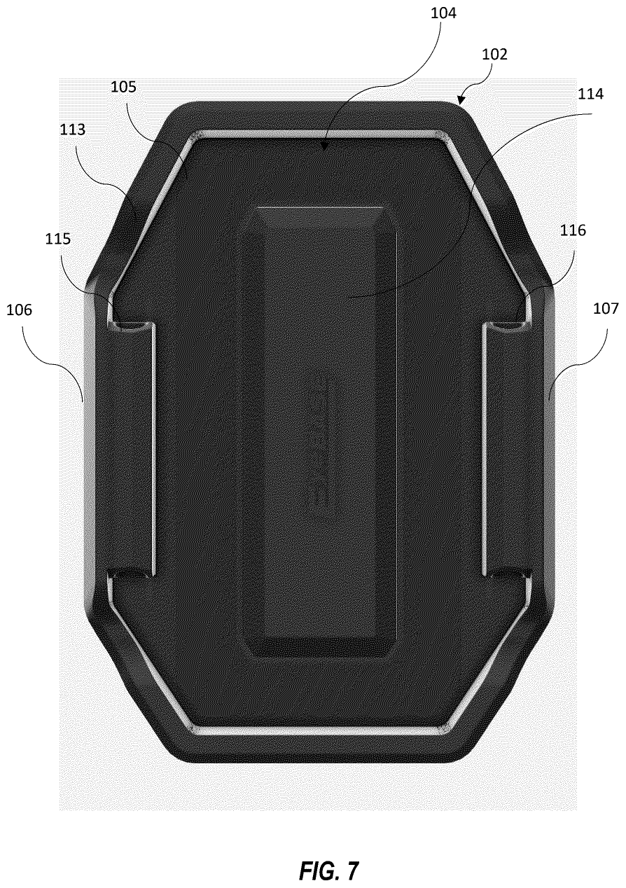

Referring to FIGS. 1-8, a stand 100 according to the present disclosure is now described. The stand 100 is illustratively for a mobile device 101 (e.g., the illustrated mobile cellular device, a tablet computing device), and comprises a housing 102. For example, the housing 102 may comprise a material of sufficient mechanical strength to support the mobile device 101, such as a plastic material (e.g., polymer plastic) or a metallic material (e.g., aluminum), or a combination thereof. The housing 102 includes a first major surface 103 abutting the mobile device 101, and a second major surface 104 opposite the first major surface and to define a recess 105. The housing 102 illustratively comprises a first side 106 extending between the first major surface 103 and the second major surface 104, and a second side 107 extending between the first major surface and the second major surface and opposite the first side. Each of the first and second sides 106, 107, and each of the top and bottom ends of the housing 102 is substantially straight. As perhaps best seen in FIGS. 6-7, the corners 108a-108d of the housing 102 are truncated/bevelled to not catch onto fabric while stored in a pocket of the user.

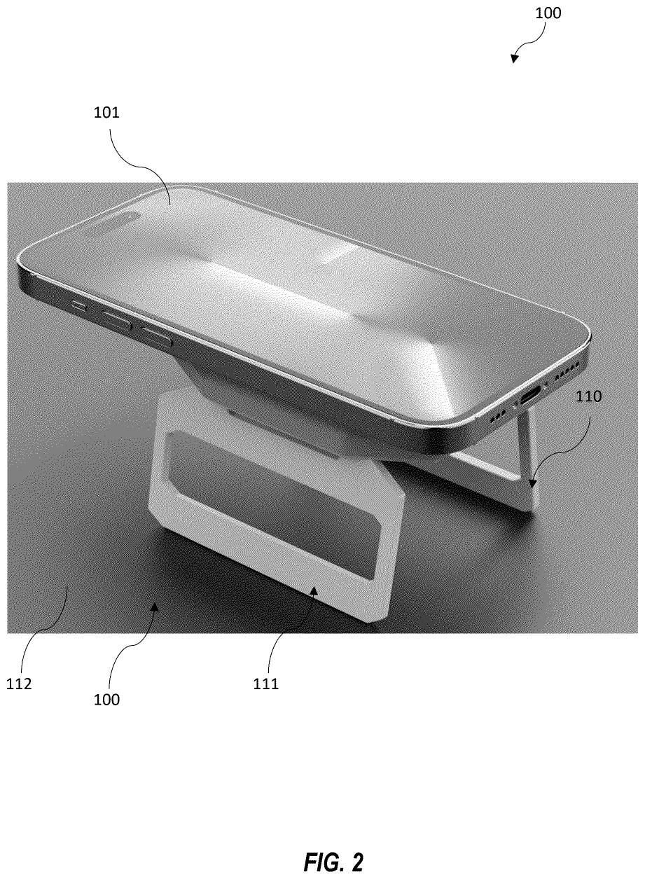

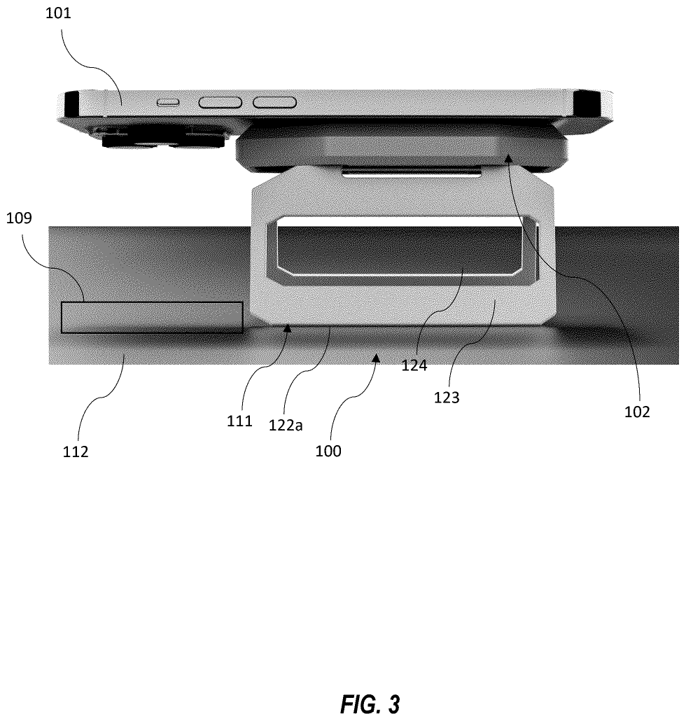

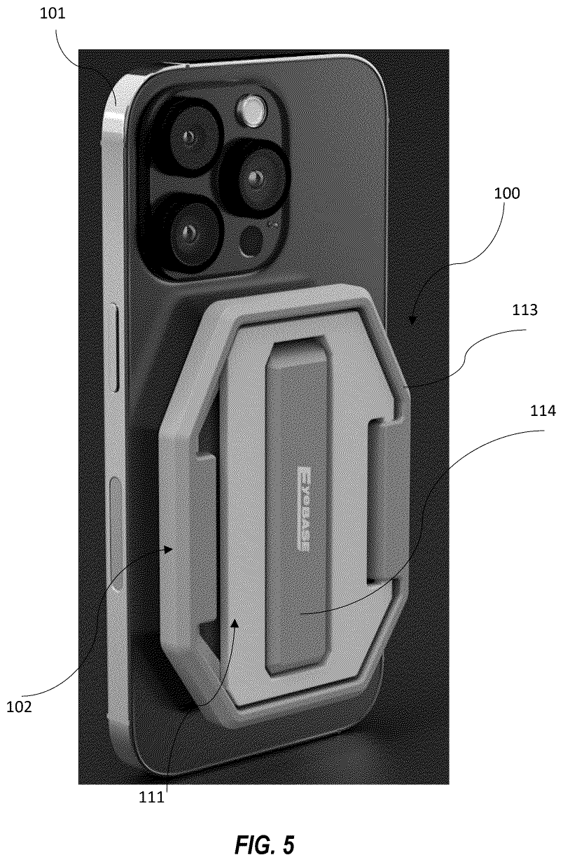

The stand 100 also includes first and second folding legs 110, 111 respectively coupled to the first side 106 and the second side 107 of the housing 102. The first and second folding legs 110, 111 switch between a first extended state (FIGS. 1-4) and a second retracted state (FIGS. 5 & 8). As perhaps best seen in FIGS. 2-3, in the first extended state, the first and second folding legs support the mobile device 101 on a surface 112 for reading a document 109. As seen in FIGS. 5 & 8, the first and second folding legs 110, 111 are within the recess 105 in the second retracted state.

As seen in FIG. 7, the recess 105 is annular in overall shape. In particular, the second major surface 104 comprises a peripheral wall 113 extending about the perimeter of the housing 102, and a medial platform 114 within the peripheral wall 113. The peripheral wall 113 and the medial platform 114 define the recess 105 therebetween. The recess 105 is rectangle-shaped, and the medial platform 114 is also rectangle-shaped. Of course, in other embodiments the recess 105 and the medial platform 114 may have other shapes, for example, round shapes or other polygonal shapes. Further, the second major surface 104 comprises first and second hinges 115, 116 respectively at the first and second sides 106, 107 and to respectively receive the first and second folding legs 110, 111. In some embodiments, the first and second pins 125a-125b may extend completely through the first and second hinges 115, 116. In other embodiments, the first and second pins 125a-125b may extend partially through the first and second hinges 115, 116.

As perhaps best seen in FIG. 6, the first major surface 103 illustratively includes an annular recess 117 for attachment to the mobile device 101. For example, the annular recess 117 may carry a suction cup interface for selectively adhering to the mobile device 101. In other embodiments, the first major surface 103 may omit the annular recess 117 and comprise an adhesive layer thereon for attachment to the mobile device 101. Of course, any form of attachment may be used in other embodiments. In other embodiments, the first major surface 103 may comprise a wallet compartment (e.g., slots to receive credit cards and IDs) to abut the mobile device 101.

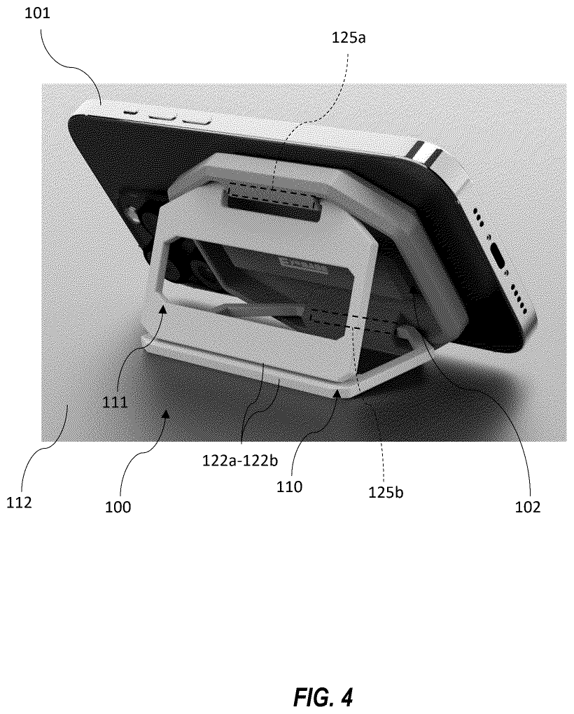

As shown in FIGS. 3-4, the first and second folding legs 110, 111 extend outward and away from the mobile device 101 to rest on the surface 112 in the first extended state. The first extended state may comprise one or more of a fully extended overhead state shown in FIG. 3 or a partially extended angled state shown in FIG. 4. In FIG. 4, each of the first and second folding legs 110, 111 defines a flat distal end 122a-122b. In this first extended state, the flat distal ends 122a-122b of the first and second folding legs 110, 111 abut each other.

As shown in FIG. 3, each of the first and second folding legs 110, 111 comprises a body 123 (i.e., D-shaped body) with a medial opening 124. Also, each of the first and second folding legs 110, 111 comprises first and second pins 125a-125b to be received by the first and second hinges 115, 116 of the housing 102. As perhaps best seen in FIG. 5, when in the second retracted state, the first and second folding legs 110, 111 are fully received by the recess 105. In other words, the first and second folding legs 110, 111 are flush with the medial platform 114 and do not protrude from the housing 102, which makes the combination of the mobile device 101 and stand 100 easier to carry for the user.

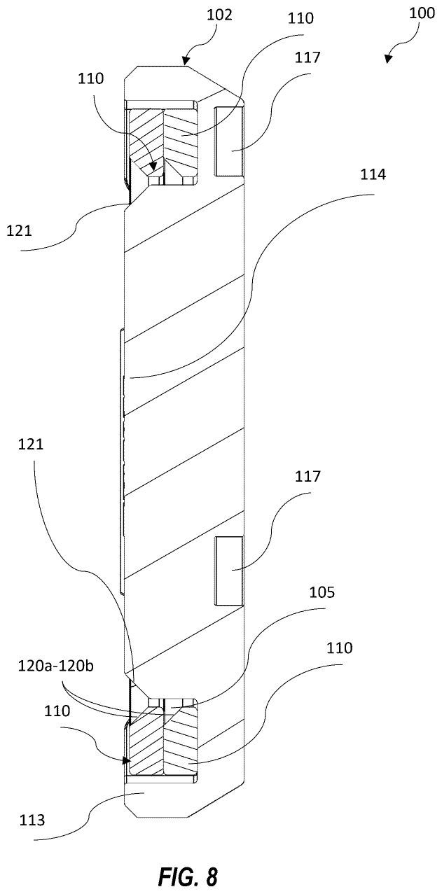

Referring now to FIG. 8, when the stand 100 is in the second retracted state, the first and second folding legs 110, 111 are fully stowed away in the recess 105. In other words, the uppermost portion of the second folding leg is substantially flush (i.e., ±5% of height of the medial platform) with the uppermost portion of the medial platform 114. Further, in this state, the first and second folding legs 110, 111 are stacked on top of each other. In particular, the first and second folding legs 110, 111 are stacked and vertically aligned with each other in the second retracted state. Also, each of the first and second folding legs 110, 111 has a truncated/bevelled inner radial edge 120a-120b, and the medial platform 114 has a truncated/bevelled out radial edge 121 facing the inner radial edge of the second folding leg. As will be appreciated, the truncated/bevelled edges 120a-120b, 121 allow the user to easily extend the first and second doling legs 110, 111.

Further, each of the first and second folding legs 110, 111 moves freely from each other. In other words, the first and second folding legs 110, 111 independently pivot about the respective first and second hinges 115, 116.

As perhaps best seen in FIG. 1, the housing 102 has a height less than that of the mobile device 101. Also, the housing 102 has a width less than that of the mobile device 101. In other words, the stand 100 has a compact formfactor, which makes in more convenient for the user to keep it installed on the mobile device 101 for long periods of time.

Another aspect is directed to a method for making a stand 100 for a mobile device 101. The method comprises forming a housing 102 having a first major surface 103 abutting the mobile device, a second major surface 104 opposite the first major surface and to define a recess 105, a first side 106 extending between the first major surface and the second major surface, and a second side 107 extending between the first major surface and the second major surface and opposite the first side. The method also includes coupling first and second folding legs 110, 111 respectively to the first side 106 and the second side 107. The first and second folding legs 110, 111 switch between a first extended state and a second retracted state, and the first and second folding legs are within the recess 105 in the second retracted state. The first and second folding legs 110, 111 extend outward and away from the mobile device 101 to rest on a surface 112 in the first extended state.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A stand for a mobile device, the stand comprising:
a housing having
a first major surface abutting the mobile device,
a second major surface opposite the first major surface and to define a recess,
a first side extending between the first major surface and the second major surface, and
a second side extending between the first major surface and the second major surface and opposite the first side; and
first and second folding legs respectively coupled to the first side and the second side, each of the first and second folding legs moving freely from each other, the first and second folding legs switching between a first extended state and a second retracted state, the first and second folding legs being within the recess in the second retracted state, the first and second folding legs extending outward and away from the mobile device to rest on a surface in the first extended state, the housing having a height less than that of the mobile device.

2. The stand of claim 1 wherein the second major surface comprises a peripheral wall extending about a perimeter of the housing, and a medial platform within the peripheral wall.

3. The stand of claim 2 wherein the second major surface defines the recess to comprise an annular-shaped recess between the peripheral wall and the medial platform.

4. The stand of claim 2 wherein the first and second folding legs are flush with the medial platform in the second retracted state.

5. The stand of claim 1 wherein each of the first and second folding legs comprises a body with a medial opening therein, and a pin coupled between the body and the housing.

6. The stand of claim 5 wherein the body of each of the first and second folding legs defines a flat distal end, the flat distal ends of the first and second folding legs to abut each other in the first extended state.

7. The stand of claim 1 wherein the first major surface comprises an annular recess for attachment to the mobile device.

8. The stand of claim 1 wherein the second major surface comprises first and second hinges respectively at the first and second sides and to respectively receive the first and second folding legs.

9. The stand of claim 1 wherein corners of the housing are truncated.

10. A stand for a mobile device, the stand comprising:
a housing having
a first major surface abutting the mobile device,
a second major surface opposite the first major surface and to define a recess,
a first side extending between the first major surface and the second major surface, and
a second side extending between the first major surface and the second major surface and opposite the first side, the second major surface comprising first and second hinges respectively at the first and second sides; and
first and second folding legs respectively coupled to the first hinge and the second hinge, each of the first and second folding legs moving freely from each other, each of the first and second folding legs comprising a body with a medial opening therein, and a pin coupled between the body and the housing;
the first and second folding legs switching between a first extended state and a second retracted state, the first and second folding legs being within the recess in the second retracted state, the first and second folding legs extending outward and away from the mobile device to rest on a surface in the first extended state, the housing having a height less than that of the mobile device.

11. The stand of claim 10 wherein the second major surface comprises a peripheral wall extending about a perimeter of the housing, and a medial platform within the peripheral wall.

12. The stand of claim 11 wherein the second major surface defines the recess to comprise an annular-shaped recess between the peripheral wall and the medial platform.

13. The stand of claim 11 wherein the first and second folding legs are flush with the medial platform in the second retracted state.

14. The stand of claim 10 wherein the body of each of the first and second folding legs defines a flat distal end, the flat distal ends of the first and second folding legs to abut each other in the first extended state.

15. The stand of claim 10 wherein the first major surface comprises an annular recess for attachment to the mobile device.

16. The stand of claim 10 wherein corners of the housing are truncated.

17. A method for making a stand for a mobile device, the method comprising:
forming a housing having
a first major surface abutting the mobile device,
a second major surface opposite the first major surface and to define a recess,
a first side extending between the first major surface and the second major surface, and
a second side extending between the first major surface and the second major surface and opposite the first side; and
coupling first and second folding legs respectively to the first side and the second side, each of the first and second folding legs moving freely from each other, the first and second folding legs switching between a first extended state and a second retracted state, the first and second folding legs being within the recess in the second retracted state, the first and second folding legs extending outward and away from the mobile device to rest on a surface in the first extended state, the housing having a height less than that of the mobile device.

18. The method of claim 17 wherein the second major surface comprises a peripheral wall extending about a perimeter of the housing, and a medial platform within the peripheral wall.

19. The method of claim 18 wherein the second major surface defines the recess to comprise an annular-shaped recess between the peripheral wall and the medial platform.

20. The method of claim 18 wherein the first and second folding legs are flush with the medial platform in the second retracted state.
